(19) United States
(12) Patent Application Publication
(10) Pub. No.: US 2025/0321313 A1
(43) Pub. Date: Oct. 16, 2025

(54) DETERMINING INDOOR OR OUTDOOR WIRELESS OPERATION

(71) Applicant: CenturyLink Intellectual Property LLC, Denver, CO (US)

(72) Inventor: Thomas Schwengler, Lakewood, CO (US)

(73) Assignee: CenturyLink Intellectual Property LLC, Denver, CO (US)

(21) Appl. No.: 19/071,183

(22) Filed: Mar. 5, 2025

Related U.S. Application Data
(60) Provisional application No. 63/632,857, filed on Apr. 11, 2024.

(51) Int. Cl. G01S 5/02; H04L 25/02; H04W 4/38

(52) U.S. Cl. CPC G01S 5/02521; H04L 25/0212; H04W 4/38

(57) ABSTRACT

Novel tools and techniques are provided for implementing a determination of indoor or outdoor wireless operation. In various examples, a computing system may receive a wireless signal. In some instances, the wireless signal is at least one of a first signal that is received by a target device. The computing system may analyze one or more radio frequency (“RF”) parameters associated with the wireless signal to identify presence of indicators of indoor or outdoor signal characteristics in the wireless signal. The computing system may determine whether the target device is located indoors or outdoors based on the analysis, and may generate a confidence score associated with the determination. The computing system may perform a first set of tasks based on the determined indoor or outdoor location of the target device and the associated confidence score.

### CROSS-REFERENCE TO RELATED APPLICATIONS

This application claims the benefit of U.S. Provisional Application No. 63/632,857 filed Apr. 11, 2024, entitled “Determining Indoor or Outdoor Wireless Operation,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing geolocation functionalities, and, more particularly, to methods, systems, and apparatuses for implementing a determination of indoor or outdoor wireless operation.

### BACKGROUND

Being able to determine indoor versus outdoor status of an access point or other wireless device may be useful for regulatory compliance. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIGS. 1A and 1B depict an example system for implementing a determination of indoor or outdoor wireless operation, in accordance with various embodiments.

FIGS. 2A-2H depict various example channel impulse response (“CIR”) graphs associated with indoor environments that may be used when implementing a determination of indoor or outdoor wireless operation, in accordance with various embodiments.

FIGS. 2I-2L depict various example CIR graphs associated with outdoor environments that may be used when implementing a determination of indoor or outdoor wireless operation, in accordance with various embodiments.

FIGS. 2M-2P depict various example probabilities of indoor or outdoor classification that may be used when implementing a determination of indoor or outdoor wireless operation, in accordance with various embodiments.

FIGS. 3, 3A, and 3B depicts various example tables listing example values representing indicators of indoor vs. outdoor signal characteristics for a 6 GHz signal or a citizens broadband radio service (“CBRS”) signal that may be used when implementing a determination of indoor or outdoor wireless operation, in accordance with various embodiments.

FIGS. 4A and 4B depict flow diagrams illustrating an example method for implementing a determination of indoor or outdoor wireless operation, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

In various examples, a computing system may receive a wireless signal. In some instances, the wireless signal is at least one of a first signal that is received by a target device. The computing system may analyze one or more radio frequency (“RF”) parameters associated with the wireless signal to identify presence of indicators of indoor or outdoor signal characteristics in the wireless signal. The computing system may determine whether the target device is located indoors or outdoors based on the analysis, and may generate a confidence score associated with the determination. The computing system may perform a first set of tasks based on the determined indoor or outdoor location of the target device and the associated confidence score.

In examples, the one or more RF parameters may include at least one of channel impulse response, mean excess delay, root mean squared (“RMS”) delay spread, coherence bandwidth, Doppler spread, coherence time, multiple input multiple output (“MIMO”) rank, or angular delay spread, and/or the like. In some examples, analyze the one or more RF parameters associated with the wireless signal may include comparing, by the computing system, a first channel impulse response that is associated with the wireless signal with a sample set of channel impulse responses that is associated with a corresponding plurality of example indoor and outdoor environments. In examples, analyzing the one or more RF parameters includes analyzing characteristics of the first channel impulse response with known indicators of indoor or outdoor signal characteristics in each channel impulse response of the sample set of channel impulse responses to determine a probability of match between the first channel impulse response and each of one or more channel impulse responses of the sample set of channel impulse responses.

The various embodiments enable improved or more efficient determination of indoor or outdoor wireless operations. These and other aspects of the determination of indoor or outdoor wireless operation are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including: receiving, by a computing system, a wireless signal, the wireless signal being at least one of a first signal that is received by a target device. The method may further include analyzing, by the computing system, one or more RF parameters associated with the wireless signal to identify presence of indicators of indoor or outdoor signal characteristics in the wireless signal. The method may further include determining, by the computing system, whether the target device is located indoors or outdoors based on the analysis; and generating, by the computing system, a confidence score associated with the determination. The method may further include performing, by the computing system, a first set of tasks based on the determined indoor or outdoor location of the target device and the associated confidence score.

In another aspect, the technology relates to a target device, including a processing system and memory coupled to the processing system. The memory includes computer executable instructions that, when executed by the processing system, causes the target device to perform operations. The operations may include receiving at least one wireless signal from a second device; analyzing one or more RF parameters associated with the at least one wireless signal to identify presence of indicators of indoor or outdoor signal characteristics; determining whether the target device is located indoors or outdoors based on the analysis; generating a confidence score associated with the determination; and performing a first set of tasks based on the determined indoor or outdoor location of the target device and the associated confidence score.

In yet another aspect, the technology relates to a method, including receiving, by a computing system, a wireless signal, the wireless signal being at least one of a first signal that is received by a target device. The method may further include comparing, by the computing system, a first channel impulse response that is associated with the wireless signal with a sample set of channel impulse responses that is associated with a corresponding plurality of example indoor and outdoor environments, by comparing characteristics of the first channel impulse response with known indicators of indoor or outdoor signal characteristics in each channel impulse response of the sample set of channel impulse responses to determine probability of match between the first channel impulse response and one or more channel impulse responses of the sample set of channel impulse responses. The method may further include determining, by the computing system, whether the target device is located indoors or outdoors based on the comparison; and generating, by the computing system, a confidence score associated with the determination. The method may further include performing, by the computing system, a first set of tasks based on the determined indoor or outdoor location of the target device and the associated confidence score.

Various modifications and additions can be made to the embodiments discussed without departing from the scope of the invention. For example, while the embodiments described above refer to particular features, the scope of this invention also includes embodiments having different combinations of features and embodiments that do not include all of the above-described features.

### Specific Exemplary Embodiments

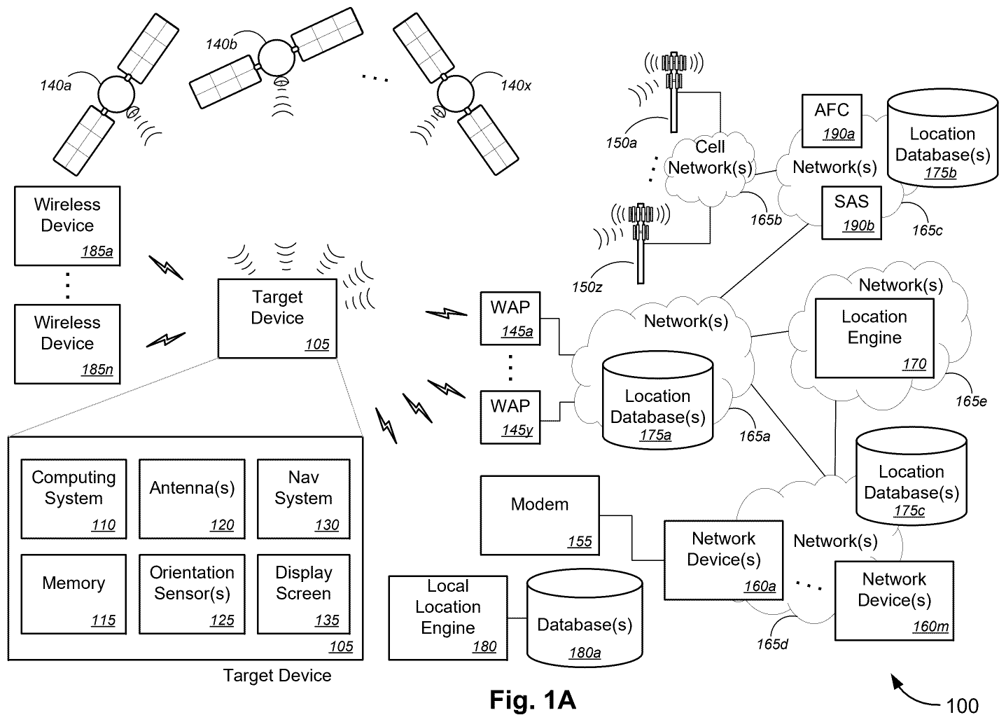

We now turn to the embodiments as illustrated by the drawings. FIGS. 1-5 illustrate some of the features of the method, system, and apparatus for implementing geolocation functionalities, and, more particularly, to methods, systems, and apparatuses for implementing a determination of indoor or outdoor wireless operation, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIGS. 1A and 1B (collectively, “FIG. 1”) depict an example system 100 for implementing a determination of indoor or outdoor wireless operation, in accordance with various embodiments. In the non-limiting example of FIG. 1A, system 100 may include target device 105. In examples, the target device 105 may include computing system 110, memory 115, and one or more antennas 120. In some cases, the target device 105 may further include at least one of an orientation sensor(s) 125, a navigation system 130, and/or a display screen 135, and/or the like. In some examples, system 100 may further include a plurality of geolocation satellites 140a-140x (collectively, “geolocation satellites 140” or “satellites 140” or the like) within satellite signal range of the target device 105. Alternatively or additionally, in examples, system 100 may further include a plurality of wireless access point (“WAP”) devices 145a-145y (collectively, “WAP devices 145” or “WAPs 145” or the like) within WAP signal range of the target device 105. Alternatively or additionally, in some instances, system 100 may further include a cellular transceiver mounted on one of a plurality of cellular towers 150a-150z (collectively, “cellular towers 150” or “towers 150” or the like). Alternatively or additionally, in some cases, system 100 may further include a modulator-demodulator (“modem”) 155 and one or more network devices 160a-160m (collectively, “network devices 160,” “network equipment 160,” “devices 160,” or “equipment 160” or the like) that are communicatively coupled with modem 155. In some instances, the one or more network devices 160 may include at least one of a network switch, a network router, or a firewall, and/or the like. System 100 may further include one or more network(s) 165a-165e (collectively, “network(s) 165” or the like).

In some embodiments, system 100 may further include location engine 170, which may be a remote or network-based location engine, and one or more location databases 175a-175c (collectively, “location database(s) 175” or the like). In some examples, system 100 may further include a local location engine 180 and corresponding database(s) 180a that are local to the target device 105 (e.g., located at the same location, facility, customer premises, or other geographical location, or the like). In examples, WAP devices 145 may communicatively couple with network(s) 165a. In some instances, location database(s) 175a may be located within network(s) 165a. In some examples, cellular towers 150 may communicatively couple with cellular network(s) 165b (e.g., 2G, 3G, 4G, and/or 5G network(s), etc.), which may communicatively couple with network(s) 165c. In some cases, location database(s) 175b may be located within network(s) 165c. In examples, location database(s) 175c and network devices 160a-160m may be located within network(s) 165d. In some instances, location engine 170 may be located within network(s) 165e. In some examples, network(s) 165a-165e may communicatively couple with each other, either directly or indirectly.

According to some embodiments, system 100 may further include one or more wireless devices 185a-185n (collectively, “wireless devices 185” or the like). Herein, m, n, x, y, and z are non-negative integer numbers that may be either all the same as each other, all different from each other, or some combination of same and different (e.g., one set of two or more having the same values with the others having different values, a plurality of sets of two or more having the same value with the others having different values, etc.). In some instances, system 100 may further include an automatic frequency coordination (“AFC”) system 190a or a spectrum allocation system (“SAS”) 190b. AFC system 190a is a system to which service providers or operators must report locations of devices that emit wireless signals (such as a WAP, etc.) operating at standard power in the 6 GHz band (e.g., Wi-Fi 6E or 7 devices, or the like), while SAS 190b is a system to which service providers or operators must repost locations of such devices operating in the 3.55-3.7 GHz band (e.g., citizens broadband radio service devices (“CBSDs”) operating in the citizens broadband radio service (“CBRS”) band, or the like). In some instances, AFC system 190a and/or SAS 190b may be located within network(s) 165c. The locations of the various components of system 100 in FIG. 1A are merely for illustration and are not limited to such, and the various components may each be located in any of these or other networks and in the same network or different networks with one or more of the other components without deviating from the scope of the various embodiments.

In some embodiments, unless otherwise indicated, network(s) 165a-165e may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 165a-165e may include an access network of the service provider (e.g., an Internet service provider (“ISP”)). In another embodiment, the network(s) 165a-165e may include a core network of the service provider and/or the Internet.

In some instances, the target device(s) 105 and the wireless devices 185a-185n may each include, but is not limited to, one of a laptop computer, a tablet computer, a smart phone, a mobile phone, a navigation system device (e.g., a global navigation satellite system (“GNSS”) receiver or device such as a Global Positioning System (“GPS”)-based device, a Global'naya Navigatsionnaya Sputnikovaya Sistema or Global Navigation Satellite System (“GLONASS”)-based device, a BeiDou Navigation Satellite System-based device, or a Galileo Positioning System-based device, etc.), a wireless access point device, a modem, a wireless hotspot device, or any suitable device capable of communicating with at least one of geolocation satellites 140a-140x, WAPs 145a-145y, cellular transceivers mounted on cellular towers 150a-150z, wireless devices 185a-185n, modem 155, and/or local location engine 180, and/or the like, over corresponding wireless connections (denoted in FIG. 1A by lightning bolt symbols or waveform symbols) or wired connections (denoted in FIG. 1A by solid lines between components).

Whether wireless devices (referred to herein as “target devices”) are operating indoor or outdoor may affect the manner in which they are legally able to operate. For example, the code of federal regulations 47 C.F.R. § 15.407 distinguishes band use and power use within the bands for indoor access points and for outdoor access points. For example, § 15.407(a)(1)(i) defines different power levels for indoor vs outdoor access points for an outdoor access point operating in the band 5.15-5.25 GHz. With respect to Wi-Fi 6E and Wi-Fi 7 devices, for instance, § 15.407(a)(4) defines a maximum power spectral density for a standard power access point and fixed client device operating in the 5.925-6.425 GHz and 6.525-6.875 GHz bands. In particular, § 15.407(a)(4) defines that the maximum power spectral density must not exceed 23 dBm equivalent isotropic radiated power (“EIRP”) in any 1 MHz band, and that the maximum EIRP over the frequency band of operation must not exceed 36 dBm. For outdoor devices, the maximum EIRP at any elevation angle above 30 degrees as measured from the horizon must not exceed 125 mW (21 dBm). Section 15.407(k)(1) requires the use of an AFC for standard devices operating in the 5.925-6.425 GHz and 6.525-6.875 GHz bands. Section 15.407(a)(5) allows low-power operations, by defining that, for an indoor access point operating in the 5.925-7.125 GHz band, the maximum power spectral density must not exceed 5 dBm EIRP in any 1 MHz band, and that the maximum EIRP over the frequency band of operation must not exceed 30 dBm.

Being able to automatically determine an indoor versus outdoor status of an access point or other wireless device may be useful in allowing devices to be deployed and operated at maximum allowable power without running afoul of regulatory requirements or requiring manual determination of indoor versus outdoor use. Defining whether a wireless device (i.e., target device) is operating indoor versus outdoor in any precise manner is difficult, and regulators have stopped short of hard definitions. It is clear that use in a home, an apartment, an office, or a warehouse is indoor use, and use on a pole, in an open space (e.g., a park, etc.), or over rural land are outdoor use. Some uses and locations remain up to debate, such as on porch, at sports venues, or at roof-less amphitheaters or facilities, etc. Present examples may enable automatic detection and decision mechanisms for defining indoor versus outdoor use with reasonable probability, as described in detail below. In particular, radio frequency (“RF”) propagation may be distinctive for indoor use compared to outdoor use, and is therefore a good tool to determine indoor use and therefore determine frequency bands, required use of AFC, and power levels allowed. RF parameters that may be used to determine indoor use include amount of multipath, delay spread, and/or Doppler spread. Indoor environments typically cause more and smaller multipaths, which causes deep fades within small distances and is referred to as small-scale fading. Outdoor environments typically cause fewer and larger multipaths. Multipath fading is significant indoors from the presence of walls and many surrounding scatterers that may reflect the wavefront differently between a transmitter and a receiver. Practically, it is useful to quantify that aspect of the propagation environment, and even to tailor the standard to perform well in such an environment.

Another aspect of wireless communication, different from the above, may include how fast parameters are changing in the wireless channel. In the time domain, that aspect may be referred to as time dispersion and may be measured by coherence time. The coherence time describes how fast the wireless channel is changing. In the frequency domain, the effect may best be described by Doppler spread, which describes how fast a transmitter, a receiver, and scatterers in-between are moving; the faster they are moving, the faster the wireless channel changes, and the more Doppler shift will be present. Generally, indoor coherence time may be larger, with indoor Doppler shifts being lower. Although some outdoor values can be lower as well, a high Doppler shift may be a better indication of an outdoor mobile environment.

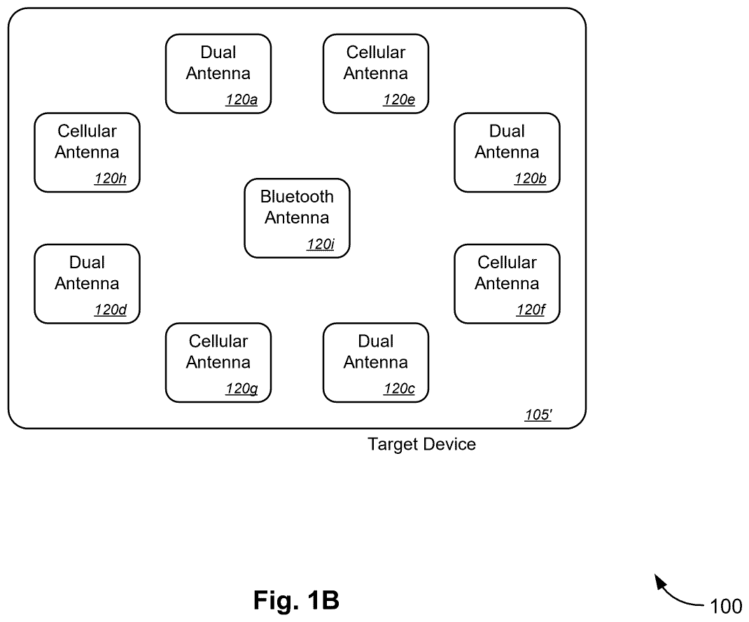

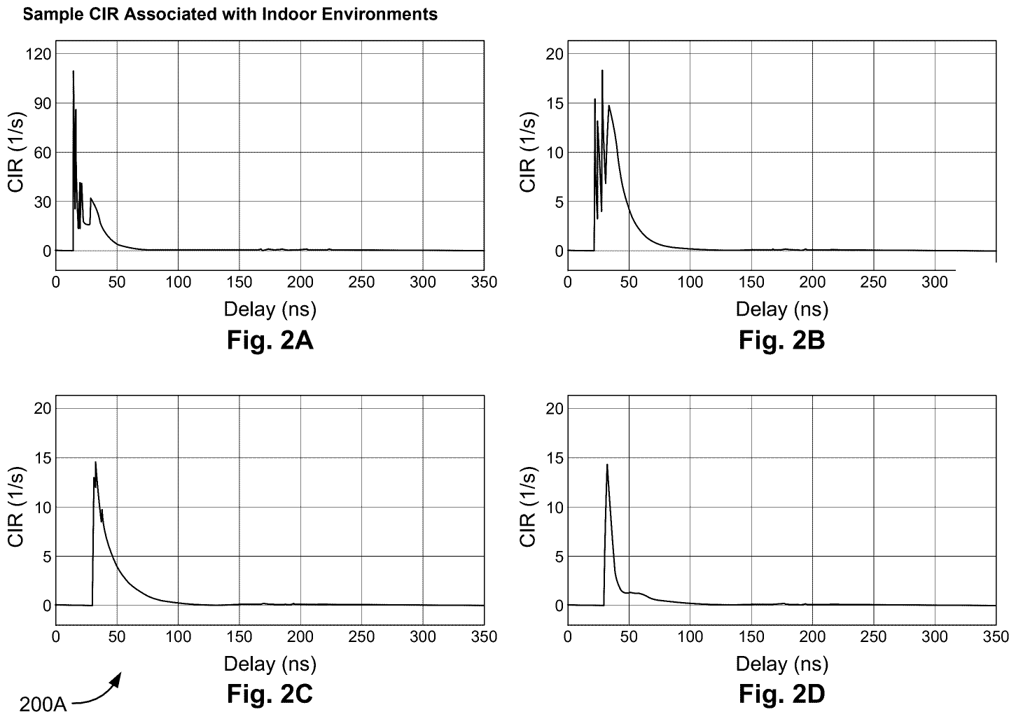

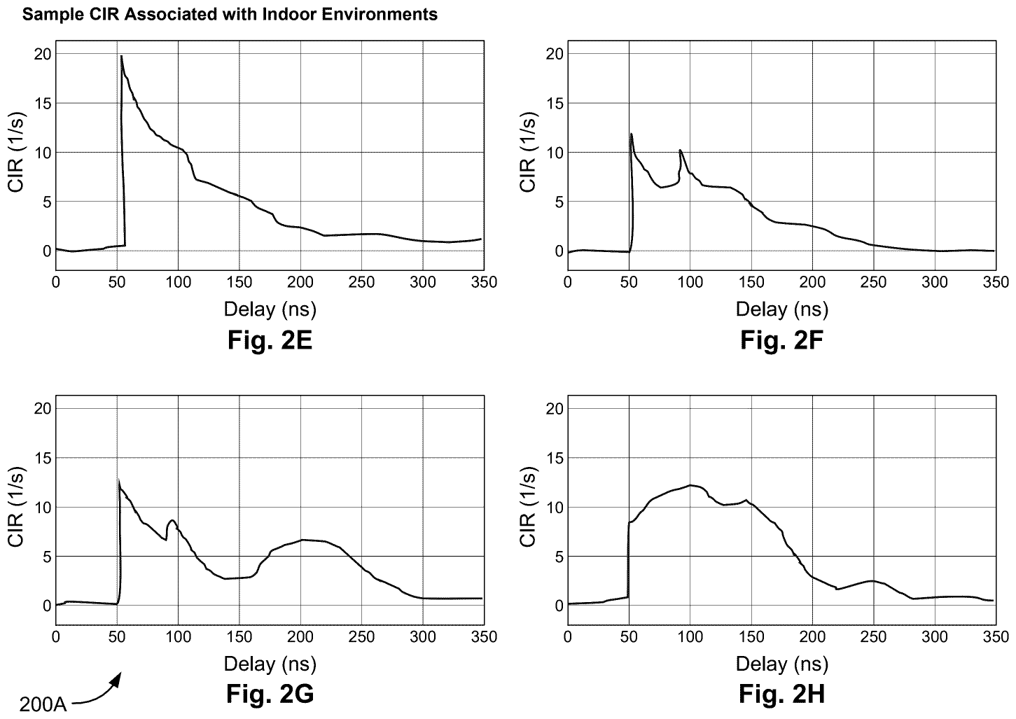

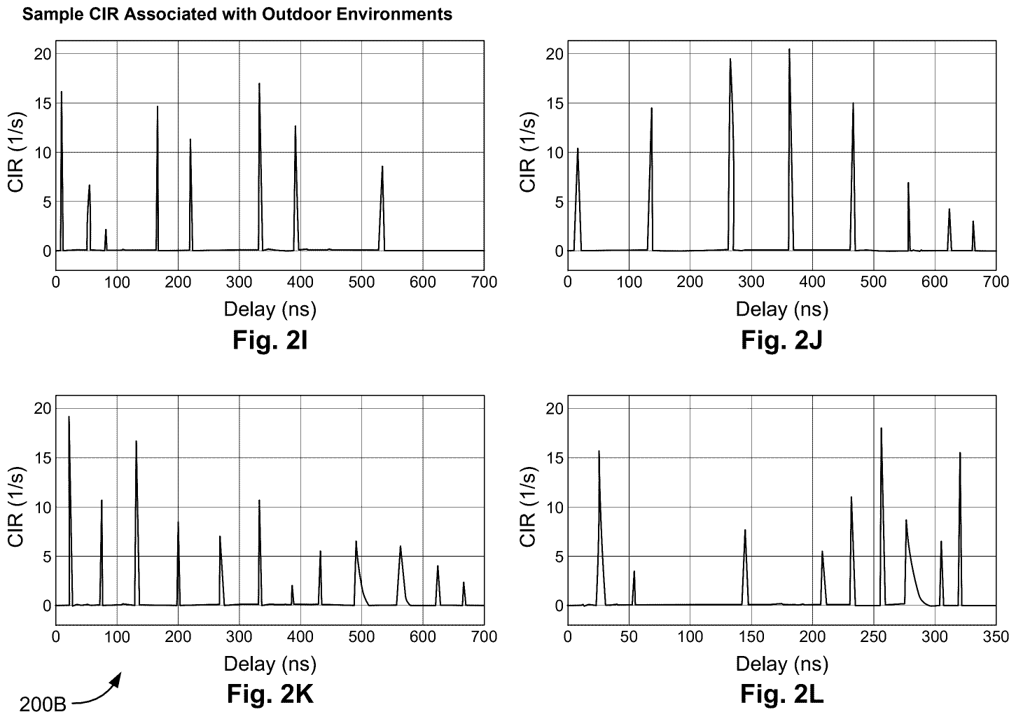

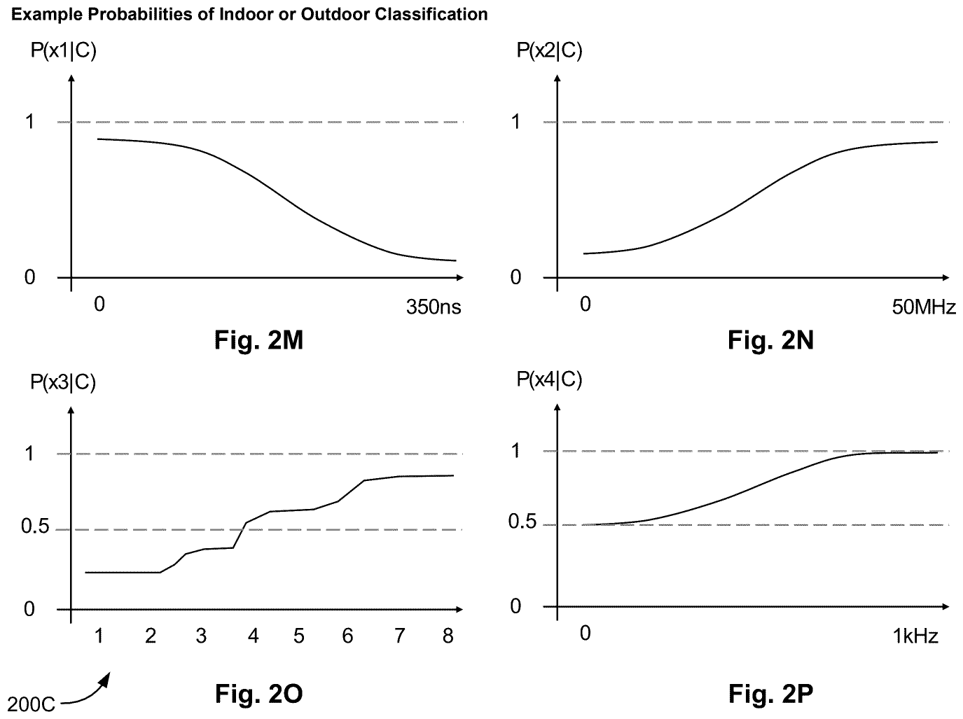

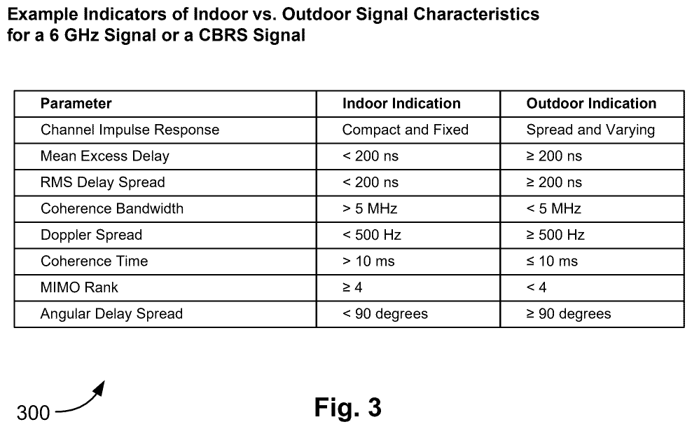

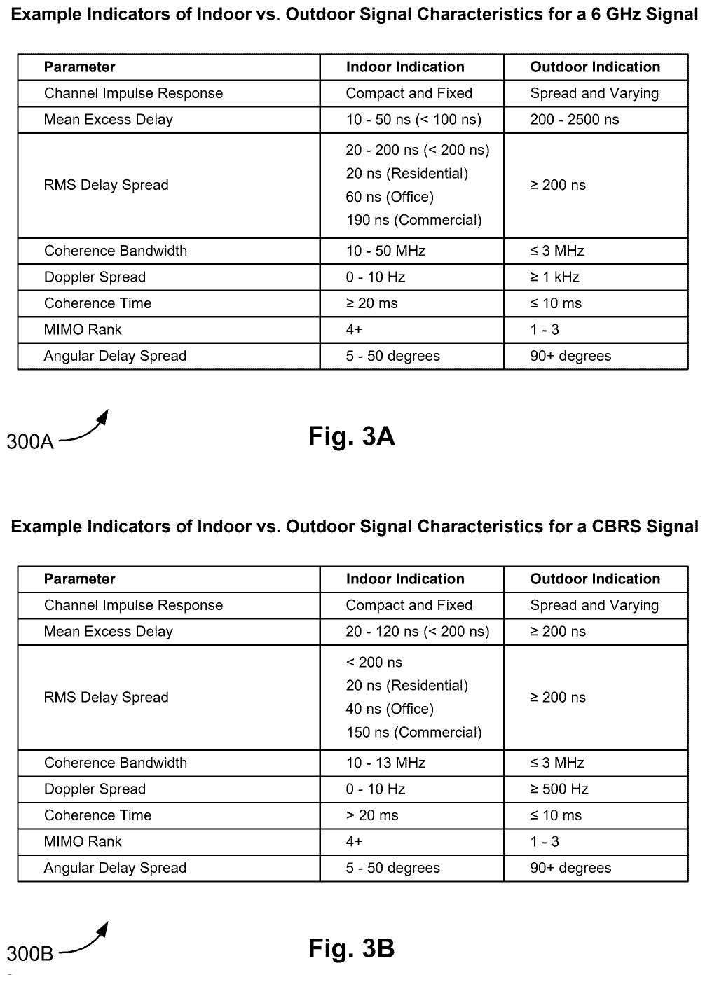

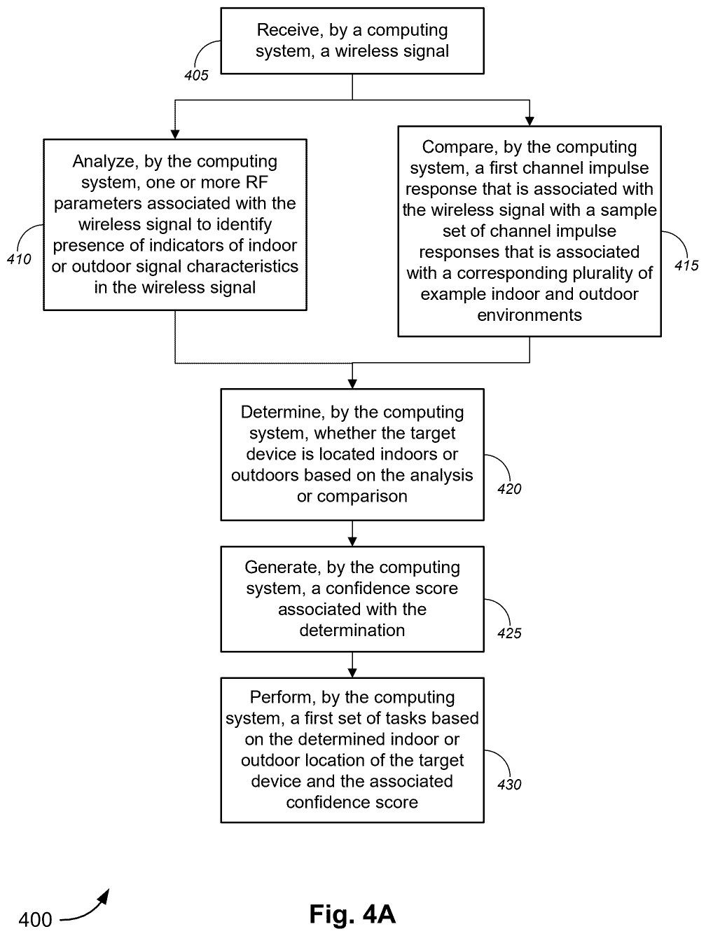

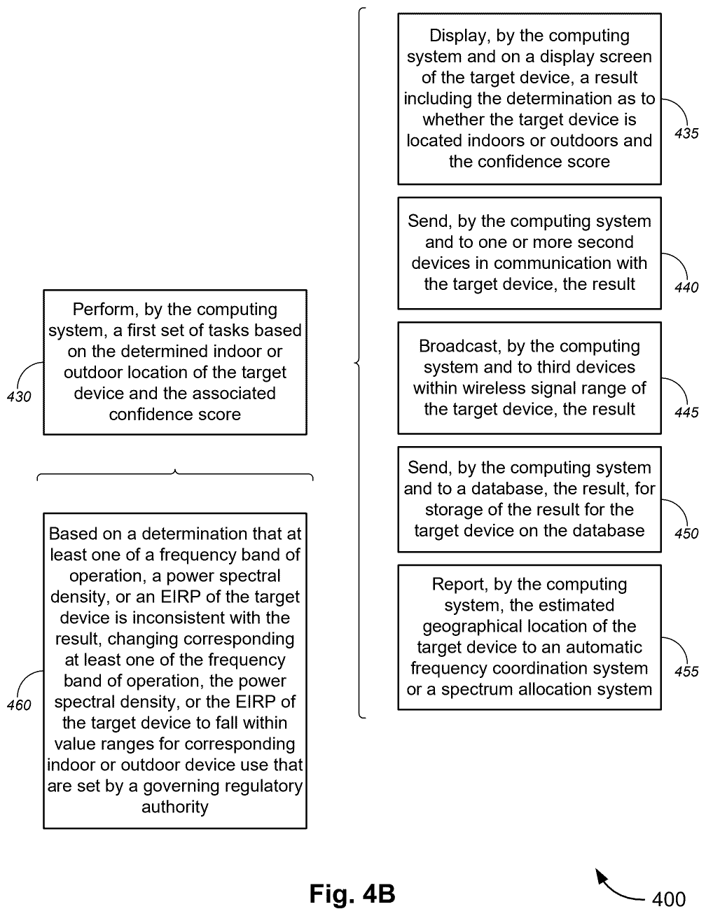

In operation, target device 105, location engine 170, and/or local location engine 180 (collectively, “computing system”) may perform methods for implementing a determination of indoor or outdoor wireless operation of the target device, as described in detail with respect to FIGS. 2-4. For instance, example channel impulse response graphs 200A and 200B as described below with respect to FIGS. 2A-2H represent inputs that are used for performing the determination of indoor or outdoor wireless operation of the target device. Example indicators of indoor or outdoor signal characteristics for a 6 GHz signal and/or a CBRS signal that may be used for performing the determination of indoor or outdoor wireless operation of the target device (such as in example method 400 of FIGS. 4A and 4B) are shown in tables 300, 300A, and 300B as described below with respect to FIGS. 3, 3A, and 3B. For example, the determination of indoor or outdoor wireless operation may be based on signals from various sources. For instance, if the target device 105 has a GNSS transceiver, then signals from two or more satellites 140a-140x may be used to measure the different RF parameters. Alternatively or additionally, if the target device 105 has wireless transceivers (e.g., transceivers based on Wi-Fi protocol, Bluetooth protocol, Z-wave protocol, ZigBee protocol, etc.), then signals from two or more wireless devices (e.g., WAPs 145a-145y, wireless devices 185a-185n etc.) may be used to measure the different RF parameters. Alternatively or additionally, if the target device 105 has cellular transceivers, then signals from cellular transceivers of two or more cellular towers 150a-150z may be used to measure the different RF parameters. Example channel impulse response graphs 200A and 200B as described below with respect to FIGS. 2A-2H, example tables 300, 300A, and 300B as described below with respect to FIGS. 3, 3A, and 3B, and example method 400 as described below with respect to FIGS. 4A and 4B, respectively, may be applied with respect to the operations of system 100 of FIG. 1.

With reference to FIG. 1B, an example target device 105′ includes a plurality of antennas 120a-120i, including dual antennas 120a-120d, cellular antennas 120e-120h, and a Bluetooth™ antenna 120i. In some cases, the dual antennas 120a-120d may each include both a transmitting antenna and a receiving antenna that are integrated together. In some instances, the cellular antennas 120e-120h may each include an antenna configured to transmit and/or receive cellular signals over cellular network(s) 165b (e.g., 2G, 3G, 4G, and/or 5G network(s), etc.). As shown in FIG. 1B, each of the dual antennas 120a-120d and each of the cellular antennas 120e-120h may be disposed on each of four sides of the target device 105′, while the Bluetooth™ antenna 120i may be disposed at a middle portion of the target device 105′.

Channel impulse response (“CIR”) may be used to distinguish between indoor and outdoor environments, which may have different channel properties and noise levels. CIR may not be directly observable, but may be inferred from a received signal. One method may be to transmit a series of pulse signals and to measure the response. The target device 105′, which may include a residential gateway, an access point, etc., may have multiple antennas, as described above with respect to FIG. 1B. One antenna may be used for transmitting signals, another for receiving signals. In examples, the antennas may be close to each other, and, to avoid direct transmit-to-receive interference, uncorrelated antennas may be used, such as the furthest one from the transmit antenna (e.g., dual antennas 120a and 120c in target device 105′, as shown in FIG. 1B) or one with different orientations (e.g., dual antennas 120a and 120b in target device 105′, as shown in FIG. 1B). In a similar manner, the setup of target device 105′ may be capable of measuring specific parameters (e.g., delay spread, Doppler shift, etc.) in lieu of the complete CIR. Some methods and algorithms that may be used for choosing between indoor and outdoor include k-nearest neighbor (“k-NN”) algorithm or naïve Bayes algorithm, which are described below with respect to example graphs 200C of FIGS. 2M-2P.

FIGS. 2A-2P (collectively, “FIG. 2”) depict various example CIR graphs 200A and 200B that are associated with either indoor environments or outdoor environments and various example probabilities of indoor or outdoor classification. FIGS. 2A-2H depict various example CIR graphs 200A associated with indoor environments that may be used when implementing a determination of indoor or outdoor wireless operation, in accordance with various embodiments. FIGS. 2I-2L depict various example CIR graphs 200B associated with outdoor environments that may be used when implementing a determination of indoor or outdoor wireless operation, in accordance with various embodiments. FIGS. 2M-2P depict example probabilities 200C of indoor or outdoor classification that may be used when implementing a determination of indoor or outdoor wireless operation, in accordance with various embodiments.

With reference to FIGS. 2A-2D, each of the CIR curves or waveforms includes compact of fixed peaks between about 10 ns and about 100 ns—that is, with a mean excess delay that is less than 100 ns or less than 200 ns, while in FIGS. 2E-2H, each of the CIR curves or waveforms include fixed peaks between about 50 ns and about 200 ns. Quite differently, referring to FIGS. 2I-2L, each of the CIR curves or waveforms includes spread and varying peaks across the delay axis, in some cases, with a mean excess delay that is greater than 200 ns.

In examples, as described above, k-NN algorithm and naïve Bayes algorithm may be two algorithms that may be used for choosing between indoor and outdoor. Referring to some examples, k-NN algorithm is a simple and effective method for classification based on similarity. In examples, the k-NN algorithm may be based on finding the k-closest neighbors of a given CIR in a training set of labeled CIRs (measured in known indoor and outdoor environments), and assigning the majority label of those neighbors to the given CIR. The similarity between two CIRs can be measured by any suitable distance metric, such as Euclidean distance between CIR curves, or the like. The k-NN algorithm may also output a confidence score, such as the inverse of the average distance between k-nearest neighbors. One parameter of the k-NN algorithm may be how to choose the value of k, which may affect the performance and accuracy of the classification. If k is too small, the algorithm may be sensitive to noise and outliers, and may produce inconsistent results. If k is too large, the k-NN algorithm may include irrelevant neighbors and may lose discriminative power. Therefore, an optimal value of k should be selected that balances between these two scenarios. The value of k may also depend on the size of training sets of CIRs. Empirical tests may be conducted on trying different values of k on the actual data and observing field results. Estimations may begin with hundreds of CIR samples being collected in various environments with a value of k between 3 and 6. As actual data may be collected over time, hundreds of thousands of samples may be used, and k may be increased to 10 or more.

Alternatively, k-NN algorithm may be generalized to multiple dimensions by considering the CIR features as a vector of attributes. Each attribute may be a numerical value, such as RMS delay spread, coherence bandwidth, Doppler spread, coherence time, MIMO rank, or noise profile, and/or the like. The distance metric may be extended to calculate the Euclidean distance between vectors, or Mahalanobis distance (which takes into account correlation between the multiple parameters). The classification process may remain the same as in the single-dimensional CIR, by finding the k-nearest neighbors and assigning the label of the majority class (either indoor class or outdoor class). The confidence score may also be computed based on the distance or similarity of the neighbors. The choice of k may depend on the number of samples and the dimensionality of the feature space. In general, higher dimensions require larger values of k to avoid overfitting and sparsity issues.

Another way to classify the environment between indoor and outdoor is to use a naïve Bayes algorithm on the multiple parameters that may be measured (e.g., RMS delay spread, Coherence bandwidth, Doppler spread, Coherence time, MIMO rank, etc.). Similar to a spam filter that decides if an email is spam or not depending on the presence of certain words, indoor or outdoor class may be determined based on values of these parameters. A naïve Bayes algorithm may update a prior probability distribution of CIR based on the likelihood of the observed signal. However, this requires a good prior knowledge of the CIR statistics, which may not be available or accurate.

A naïve Bayes algorithm is a probabilistic method that applies the Bayes' theorem to classify data based on prior knowledge and evidence. In some examples, the class label may be either indoor or outdoor, and the features may be the measured RF parameters, such as RMS delay spread, coherence bandwidth, Doppler spread, coherence time, MIMO rank, etc. The naïve Bayes algorithm may calculate the a posteriori probability of each class given the feature values, and may assign the class with the highest probability. For example, if the RMS delay spread is high, the coherence bandwidth is low, and the Doppler spread is low, the naïve Bayes algorithm may infer that the environment is indoor with a high probability. The naïve Bayes algorithm may be trained using labeled data, or using some prior assumptions about the distribution of the features and the classes.

The a posteriori probability of a class C (e.g., indoor or outdoor) given the feature values x1, x2, . . . , xn may be calculated using the Bayes' theorem as follows:

$$P ( C \vert x 1 , x 2 , … , xn ) = P ( x 1 , x 2 , … , xn \vert C ) P ( C ) / P ( x 1 , x 2 , … , xn ) . \qquad ( Eqn . 1 )$$

Using the naïve assumption that the features are conditionally independent given the class, we can simplify the formula as:

$$P ( C \vert x 1 , x 2 , … , xn ) = P ( x 1 \vert C ) P ( x 2 \vert C ) … P ( x n \vert C ) P ( C ) / P ( x 1 , x 2 , … , xn ) . \qquad ( Eqn . 2 )$$

This is an illustration for explanation purposes; in reality, not all the parameters may be independent and the actual probability may take into account the correlation between parameters. To classify a new instance, the class that maximizes this probability may be chosen. This is equivalent to choosing the class that maximizes the numerator, since the denominator is constant for all classes. Therefore, the following rule may be used:

$$C = arg max \{ P ( x 1 \vert C ) P ( x 2 \vert C ) … P ( xn \vert C ) \} . \qquad ( Eqn . 3 )$$

For convenience, the logarithm of the above equation may be used and the sum of the probabilities may be maximized. Individual weights (e.g., wl to wn) may be given to each parameters based on empirical data, which may result in the following equation:

$$C = arg max \{ w 1 P ( x 1 \vert C ) + w 2 P ( x 2 \vert C ) + \text{…} + wn P ( xn \vert C ) \} \qquad ( Eqn . 4 )$$

In examples, various probabilities as shown in FIGS. 2M-2P may be estimated. For example, for x1=RMS delay spread, P(x1|C) (which may be the probability of being indoor given a RMS value) may be calculated. Specific values such as P(x1<200 ns|indoor)=90%, or a function for P(x1|C) showing that the indoor probability decreases as a function of RMS values, may be used, as shown, e.g., in FIG. 2M. Similarly, x2 may be the coherence bandwidth, probability of being indoor increases with x2, as shown, e.g., in FIG. 2N. And so on for all other parameters. Parameters like rank, may have a more discrete behavior, as shown, e.g., in FIG. 2O. As shown in FIG. 2M-2P, most curves may not extend from 0 to 1 (as the probability may rarely be 100% indoor or outdoor), though some might be higher, such as a high Doppler shift showing motion at 50+ mph is likely to be seen outdoors only. So, for example, if x4 is Doppler spread, a low Doppler spread may exist equally indoor and outdoor (50%) but a very high Doppler spread is extremely likely to be outdoor (close to 100%), as shown, e.g., in FIG. 2P. The resulting weighted sum of all or a subset of these parameters may provide a final estimation of probability of being indoor or outdoor.

FIGS. 3, 3A, and 3B (collectively, “FIG. 3”) depict various example tables 300, 300A, and 300B listing example values representing indicators of indoor vs. outdoor signal characteristics for a 6 GHz signal or a citizens broadband radio service (“CBRS”) signal that may be used when implementing a determination of indoor or outdoor wireless operation, in accordance with various embodiments.

With reference to FIG. 3, example table 300 may list indicators of indoor and outdoor environments by RF parameters for a 6 GHz signal or a CBRS signal. In examples, the one or more RF parameters may include at least one of channel impulse response, mean excess delay, root mean squared (“RMS”) delay spread, coherence bandwidth, Doppler spread, coherence time, multiple input multiple output (“MIMO”) rank, or angular delay spread, and/or the like. In some examples, an indicator of indoor signal characteristics for a 6 GHz signal or a CBRS signal may include one or more of:
(1) a channel impulse response that is compact and fixed;
(2) a mean excess delay that is less than 200 ns;
(3) an RMS delay spread that is less than 200 ns;
(4) a coherence bandwidth that is greater than 5 MHz;
(5) a Doppler spread that is that is less than 500 Hz;
(6) a coherence time that is greater than 10 ms;
(7) a MIMO rank that is 4 or greater; and/or
(8) an angular delay spread that is less than 90 degrees.

In examples, an indicator of outdoor signal characteristics for a 6 GHz signal or a CBRS signal may include one or more of:
(1) a channel impulse response that is spread and varying;
(2) a mean excess delay that is 200 ns or greater;
(3) an RMS delay spread that is 200 ns or greater;
(4) a coherence bandwidth that is less than 5 MHz;
(5) a Doppler spread that is that is 500 Hz or greater;
(6) a coherence time that is 10 ms or less;
(7) a MIMO rank that is less than 4; and/or
(8) an angular delay spread that is 90 degrees or greater.

As used herein, MIMO rank refers to the amount of statistically independent paths outdoors in the line of sight environments. For example, a MIMO rank of 2 may correspond to a direct line of sight at two different polarizations, while a higher MIMO rank of 4 or more may correspond to indoor wireless operations due to the signals bouncing off interior walls. Referring to FIG. 3A, example table 300A may list indicators of indoor and outdoor environments by RF parameters for a 6 GHz signal. In some examples, an indicator of indoor signal characteristics for a 6 GHz signal may include one or more of:
(1) a channel impulse response that is compact and fixed;
(2) a mean excess delay that is in a range from 10 to 50 ns or is less than 100 ns;
(3) an RMS delay spread that is in a range from 20 to 200 ns or is less than 200 ns;
   (3a) an RMS delay spread that is approximately 20 ns for a residential building;
   (3b) an RMS delay spread that is approximately 60 ns for an office building;
   (3c) an RMS delay spread that is approximately 190 ns for a commercial building;
(4) a coherence bandwidth that is in a range from 10 to 50 MHz;
(5) a Doppler spread that is that is in a range from 0 to 10 Hz;
(6) a coherence time that is 20 ms or greater;
(7) a MIMO rank that is 4 or greater; and/or
(8) an angular delay spread that is in a range from 5 to 50 degrees.

In examples, an indicator of outdoor signal characteristics for a 6 GHz signal may include one or more of:
(1) a channel impulse response that is spread and varying;
(2) a mean excess delay that is in a range from 200 to 2500 ns or is 200 ns or greater;
(3) an RMS delay spread that is 200 ns or greater;
(4) a coherence bandwidth that is 3 MHz or less;
(5) a Doppler spread that is that is 1 kHz or greater;
(6) a coherence time that is 10 ms or less;
(7) a MIMO rank that is in a range from 1 to 3; and/or
(8) an angular delay spread that is 90 degrees or greater.

Turning to FIG. 3B, example table 300B may list indicators of indoor and outdoor environments by RF parameters for a CBRS signal. In some examples, an indicator of indoor signal characteristics for a CBRS signal may include one or more of:
(1) a channel impulse response that is compact and fixed;
(2) a mean excess delay that is in a range from 20 to 120 ns or is less than 200 ns;
(3) an RMS delay spread that is less than 200 ns;
   (3a) an RMS delay spread that is approximately 20 ns for a residential building;
   (3b) an RMS delay spread that is approximately 40 ns for an office building;
   (3c) an RMS delay spread that is approximately 150 ns for a commercial building;
(4) a coherence bandwidth that is in a range from 10 to 13 MHz;
(5) a Doppler spread that is that is in a range from 0 to 10 Hz;
(6) a coherence time that is greater than 20 ms;
(7) a MIMO rank that is 4 or greater; and/or
(8) an angular delay spread that is in a range from 5 to 50 degrees.

In examples, an indicator of outdoor signal characteristics for a CBRS signal may include one or more of:
(1) a channel impulse response that is spread and varying;
(2) a mean excess delay that is 200 ns or greater;
(3) an RMS delay spread that is 200 ns or greater;
(4) a coherence bandwidth that is 3 MHz or less;
(5) a Doppler spread that is that is 500 Hz or greater;
(6) a coherence time that is 10 ms or less;
(7) a MIMO rank that is in a range from 1 to 3; and/or
(8) an angular delay spread that is 90 degrees or greater.

FIGS. 4A and 4B (collectively, “FIG. 4”) depict flow diagrams illustrating an example method 400 for implementing a determination of indoor or outdoor wireless operation, in accordance with various embodiments.

In the non-limiting embodiment of FIG. 4A, method 400, at operation 405, may include receiving, by a computing system, a wireless signal. In some cases, the wireless signal may be at least one of a first signal that is received by a target device. In some instances, the computing system may include one of a computing system of the target device, a local location engine, a network-based location engine, a server, a cloud computing system, or a distributed computing system, and/or the like. In some examples, the target device may include one of a smart phone, a mobile phone, a tablet computer, a laptop computer, a navigation system device, a WAP device, a modem, or wireless hotspot device, and/or the like. Method 400 either may continue onto the process at operation 410 and/or may continue onto the process at operation 415.

At operation 410, method 400 may include analyzing, by the computing system, one or more RF parameters associated with the wireless signal to identify presence of indicators of indoor or outdoor signal characteristics in the wireless signal. In examples, the one or more RF parameters may include at least one of channel impulse response, mean excess delay, RMS delay spread, coherence bandwidth, Doppler spread, coherence time, MIMO rank, or angular delay spread, and/or the like. Example indicators of indoor or outdoor signal characteristics in the wireless signal, by RF parameters, are shown in the tables of FIGS. 3, 3A, and 3B, for 6 GHz signals or CBRS signals.

Alternatively or additionally, method 400, at operation 415, may include comparing, by the computing system, a first channel impulse response that is associated with the wireless signal with a sample set of channel impulse responses that is associated with a corresponding plurality of example indoor and outdoor environments. Examples of the sample set of channel impulse responses are shown in the example graphs of FIGS. 2A-2D (showing example CIR graphs 200A associated with indoor environments) and FIGS. 2E-2H (showing example CIR graphs 200B associated with outdoor environments). In examples, comparing the first channel impulse response may include comparing characteristics of the first channel impulse response with known indicators of indoor or outdoor signal characteristics in each channel impulse response of the sample set of channel impulse responses to determine probability of match between the first channel impulse response and one or more channel impulse responses of the sample set of channel impulse responses. In some cases, at least some of the sample set of channel impulse responses may include labels added by an installer, a trusted entity, or other trusted sources indicating whether each of the at least some channel impulse responses is indicative of the target device being indoor or outdoor. The sample set of channel impulse responses may be retrieved or accessed from a database. In some examples, an artificial intelligence (“AI”) system may be trained to perform the analysis (at operation 410) or the comparison (at operation 415).

Method 400 may further include, at operation 420, determining, by the computing system, whether the target device is located indoors or outdoors based on the analysis (from operation 410) or the comparison (from operation 415). At operation 425, method 400 may include generating, by the computing system, a confidence score associated with the determination. In examples, the confidence score may include one of a percentage score, an alphanumeric score, or a numerical score, and/or the like. In some examples, in the case that the confidence score is inconclusive (e.g., 50±10% or 50±20%, etc.), the computing system may make a default determination of outdoor use, as the outdoor use definitions under § 15.407 (as described above) are more stringent compared with those of indoor use. Method 400 may further include performing, by the computing system, a first set of tasks based on the determined indoor or outdoor location of the target device and the associated confidence score (at operation 430).

With reference to FIG. 4B, in an example, performing the first set of tasks (at operation 430) may include displaying, by the computing system and on a display screen of the target device, a result including the determination as to whether the target device is located indoors or outdoors and the confidence score (at operation 435). Alternatively or additionally, in another example, performing the first set of tasks (at operation 430) may include sending, by the computing system and to one or more second devices in communication with the target device, the result including the determination as to whether the target device is located indoors or outdoors and the confidence score (at operation 440). Alternatively or additionally, in yet another example, performing the first set of tasks (at operation 430) may include broadcasting, by the computing system and to third devices within wireless signal range of the target device, the result including the determination as to whether the target device is located indoors or outdoors and the confidence score (at operation 445).

Alternatively or additionally, in still another example, performing the first set of tasks (at operation 430) may include sending, by the computing system and to a database, the result including the determination as to whether the target device is located indoors or outdoors and the confidence score, for storage of the result for the target device on the database (at operation 450). Alternatively or additionally, in another example, performing the first set of tasks (at operation 430) may include reporting, by the computing system, the estimated geographical location of the target device to an automatic frequency coordination system or a spectrum allocation system (at operation 455). Alternatively or additionally, in yet another example, performing the first set of tasks (at operation 430) may include, based on a determination that at least one of a frequency band of operation, a power spectral density, or an EIRP of the target device is inconsistent with the result, changing corresponding at least one of the frequency band of operation, the power spectral density, or the EIRP of the target device to fall within frequency ranges, a maximum power spectral density, or a maximum EIRP for corresponding indoor or outdoor device use that are set by a governing regulatory authority (e.g., as described above with respect to FIG. 1 and 47 C.F.R. § 15.407) (at operation 460).

While the techniques and procedures in method 400 is depicted and/or described in a certain order for purposes of illustration, it should be appreciated that certain procedures may be reordered and/or omitted within the scope of various embodiments. Moreover, while the method 400 may be implemented by or with (and, in some cases, are described below with respect to) the systems, examples, or embodiments 100, 200A, 200B, 300, 300A, and 300B of FIGS. 1, 2A-2D, 2E-2H, 3, 3A, and 3B, respectively (or components thereof), such methods may also be implemented using any suitable hardware (or software) implementation. Similarly, while each of the systems, examples, or embodiments 100, 200A, 200B, 300, 300A, and 300B of FIGS. 1, 2A-2D, 2E-2H, 3, 3A, and 3B, respectively (or components thereof), can operate according to the method 400 (e.g., by executing instructions embodied on a computer readable medium), the systems, examples, or embodiments 100, 200A, 200B, 300, 300A, and 300B of FIGS. 1, 2A-2D, 2E-2H, 3, 3A, and 3B can each also operate according to other modes of operation and/or perform other suitable procedures.

### Exemplary System and Hardware Implementation

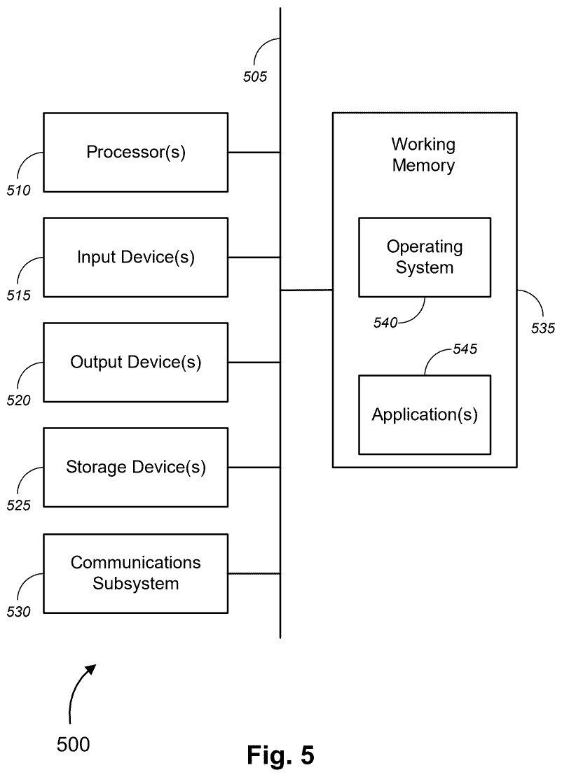

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., target device 105, computing system 110, navigation system 130, location engine 170, local location engine 180, and wireless devices 185a-185n, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., target device 105, computing system 110, navigation system 130, location engine 170, local location engine 180, and wireless devices 185a-185n, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without-certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system, a wireless signal, the wireless signal being at least one of a first signal that is received by a target device;
analyzing, by the computing system, one or more radio frequency (“RF”) parameters associated with the wireless signal to identify presence of indicators of indoor or outdoor signal characteristics in the wireless signal;
determining, by the computing system, whether the target device is located indoors or outdoors based on the analysis;
generating, by the computing system, a confidence score associated with the determination; and
performing, by the computing system, a first set of tasks based on the determined indoor or outdoor location of the target device and the associated confidence score.

2. The method of claim 1, wherein the computing system is one of a computing system of the target device, a local location engine, a network-based location engine, a server, a cloud computing system, or a distributed computing system.

3. The method of claim 1, wherein the target device is one of a smart phone, a mobile phone, a tablet computer, a laptop computer, a navigation system device, a wireless access point (“WAP”) device, a modem, or wireless hotspot device.

4. The method of claim 1, further comprising:
comparing, by the computing system, a first channel impulse response that is associated with the wireless signal with a sample set of channel impulse responses that is associated with a corresponding plurality of example indoor and outdoor environments;
wherein analyzing the one or more RF parameters comprises analyzing characteristics of the first channel impulse response with known indicators of indoor or outdoor signal characteristics in each channel impulse response of the sample set of channel impulse responses to determine a probability of match between the first channel impulse response and each of one or more channel impulse responses of the sample set of channel impulse responses;
wherein the confidence score is based at least in part on an aggregation or an average of the determined probability of match between the first channel impulse response and each of the one or more channel impulse responses.

5. The method of claim 1, wherein the one or more RF parameters include at least one of channel impulse response, mean excess delay, root mean squared (“RMS”) delay spread, coherence bandwidth, Doppler spread, coherence time, multiple input multiple output (“MIMO”) rank, or angular delay spread.

6. The method of claim 5, wherein an indicator of indoor signal characteristics for a 6 GHz signal or a citizens broadband radio service (“CBRS”) signal includes one or more of:
a channel impulse response that is compact and fixed;
a mean excess delay that is less than 200 ns;
an RMS delay spread that is less than 200 ns;
a coherence bandwidth that is greater than 5 MHz;
a Doppler spread that is that is less than 500 Hz;
a coherence time that is greater than 10 ms;
a MIMO rank that is 4 or greater; or
an angular delay spread that is less than 90 degrees.

7. The method of claim 6, wherein the indicator of indoor signal characteristics of the 6 GHz signal further includes one or more of:
a mean excess delay that is in a range from 10 to 50 ns;
an RMS delay spread that is in a range from 20 to 200 ns;
an RMS delay spread that is approximately 20 ns for a residential building;
an RMS delay spread that is approximately 60 ns for an office building;
an RMS delay spread that is approximately 190 ns for a commercial building;
a coherence bandwidth that is in a range from 10 to 50 MHz;
a Doppler spread that is that is in a range from 0 to 10 Hz;
a coherence time that is 20 ms or greater; or
an angular delay spread that is in a range from 5 to 50 degrees.

8. The method of claim 6, wherein the indicator of indoor signal characteristics of the CBRS signal further includes one or more of:
a mean excess delay that is in a range from 20 to 120 ns;
an RMS delay spread that is approximately 20 ns for a residential building;
an RMS delay spread that is approximately 40 ns for an office building;
an RMS delay spread that is approximately 150 ns for a commercial building;
a coherence bandwidth that is in a range from 10 to 13 MHz;
a Doppler spread that is that is in a range from 0 to 10 Hz;
a coherence time that is 20 ms or greater; or
an angular delay spread that is in a range from 5 to 50 degrees.

9. The method of claim 5, wherein an indicator of outdoor signal characteristics for a 6 GHz signal or a CBRS signal includes one or more of:
a channel impulse response that is spread and varying;
a mean excess delay that is 200 ns or greater;
an RMS delay spread that is 200 ns or greater;
a coherence bandwidth that is less than 5 MHz;
a Doppler spread that is that is 500 Hz or greater;
a coherence time that is 10 ms or less;
a MIMO rank that is less than 4; or
an angular delay spread that is 90 degrees or greater.

10. The method of claim 9, wherein the indicator of outdoor signal characteristics of the 6 GHz signal further includes one or more of:
a mean excess delay that is in a range from 200 to 2500 ns;
a coherence bandwidth that is 3 MHz or less;
a Doppler spread that is that is 1 kHz or greater; or
a MIMO rank that is in a range from 1 to 3.

11. The method of claim 9, wherein the indicator of outdoor signal characteristics of the CBRS signal further includes one or more of:
a coherence bandwidth that is 3 MHz or less; or
a MIMO rank that is in a range from 1 to 3.

12. The method of claim 1, wherein the first task comprises at least one of:
displaying, by the computing system and on a display screen of the target device, a result including the determination as to whether the target device is located indoors or outdoors and the confidence score;
sending, by the computing system and to one or more second devices in communication with the target device, the result including the determination as to whether the target device is located indoors or outdoors and the confidence score;
broadcasting, by the computing system and to third devices within wireless signal range of the target device, the result including the determination as to whether the target device is located indoors or outdoors and the confidence score;
sending, by the computing system and to a database, the result including the determination as to whether the target device is located indoors or outdoors and the confidence score, for storage of the result for the target device on the database;
reporting, by the computing system, the estimated geographical location of the target device to an automatic frequency coordination system or a spectrum allocation system; or
based on a determination that at least one of a frequency band of operation, a power spectral density, or an equivalent isotropic radiated power (“EIRP”) of the target device is inconsistent with the result, changing corresponding at least one of the frequency band of operation, the power spectral density, or the EIRP of the target device to fall within frequency ranges, a maximum power spectral density, or a maximum EIRP for corresponding indoor or outdoor device use that are set by a governing regulatory authority.

13. A target device, comprising:
a processing system; and
memory coupled to the processing system, the memory comprising computer executable instructions that, when executed by the processing system, causes the target device to perform operations comprising:
receiving at least one wireless signal from a second device;
analyzing one or more radio frequency (“RF”) parameters associated with the at least one wireless signal to identify presence of indicators of indoor or outdoor signal characteristics;
determining whether the target device is located indoors or outdoors based on the analysis;
generating a confidence score associated with the determination; and
performing a first set of tasks based on the determined indoor or outdoor location of the target device and the associated confidence score.

14. The system of claim 13, wherein the target device is one of a smart phone, a mobile phone, a tablet computer, a laptop computer, a navigation system device, a wireless access point (“WAP”) device, a modem, or wireless hotspot device.

15. The system of claim 13, wherein the one or more RF parameters include at least one of channel impulse response, mean excess delay, root mean squared (“RMS”) delay spread, coherence bandwidth, Doppler spread, coherence time, multiple input multiple output (“MIMO”) rank, or angular delay spread.

16. The system of claim 13, wherein the operations further comprise:
comparing, by the computing system, a first channel impulse response that is associated with the wireless signal with a sample set of channel impulse responses that is associated with a corresponding plurality of example indoor and outdoor environments;
wherein analyzing the one or more RF parameters comprises analyzing characteristics of the first channel impulse response with known indicators of indoor or outdoor signal characteristics in each channel impulse response of the sample set of channel impulse responses to determine probability of match between the first channel impulse response and one or more channel impulse responses of the sample set of channel impulse responses;
wherein the confidence score is based at least in part on an aggregation or an average of the determined probability of match between the first channel impulse response and each of the one or more channel impulse responses.

17. A method, comprising:
receiving, by a computing system, a wireless signal, the wireless signal being at least one of a first signal that is received by a target device;
comparing, by the computing system, a first channel impulse response that is associated with the wireless signal with a sample set of channel impulse responses that is associated with a corresponding plurality of example indoor and outdoor environments, by comparing characteristics of the first channel impulse response with known indicators of indoor or outdoor signal characteristics in each channel impulse response of the sample set of channel impulse responses to determine probability of match between the first channel impulse response and one or more channel impulse responses of the sample set of channel impulse responses;
determining, by the computing system, whether the target device is located indoors or outdoors based on the comparison;
generating, by the computing system, a confidence score associated with the determination; and
performing, by the computing system, a first set of tasks based on the determined indoor or outdoor location of the target device and the associated confidence score.

18. The method of claim 17, wherein the known indicators of indoor or outdoor signal characteristics in the sample set of channel impulse responses includes one or more RF parameters including at least one of channel impulse response, mean excess delay, root mean squared (“RMS”) delay spread, coherence bandwidth, Doppler spread, coherence time, multiple input multiple output (“MIMO”) rank, or angular delay spread.

19. The method of claim 18, wherein an indicator of indoor signal characteristics for a 6 GHz signal or a citizens broadband radio service (“CBRS”) signal includes one or more of:
a channel impulse response that is compact and fixed;
a mean excess delay that is less than 200 ns;
an RMS delay spread that is less than 200 ns;
a coherence bandwidth that is greater than 5 MHz;
a Doppler spread that is that is less than 500 Hz;
a coherence time that is greater than 10 ms;
a MIMO rank that is 4 or greater; or
an angular delay spread that is less than 90 degrees.

20. The method of claim 18, wherein an indicator of outdoor signal characteristics for a 6 GHz signal or a CBRS signal includes one or more of:
a channel impulse response that is spread and varying;
a mean excess delay that is 200 ns or greater;
an RMS delay spread that is 200 ns or greater;
a coherence bandwidth that is less than 5 MHz;
a Doppler spread that is that is 500 Hz or greater;
a coherence time that is 10 ms or less;
a MIMO rank that is less than 4; or
an angular delay spread that is 90 degrees or greater.
